(19) United States
(12) Patent Application Publication
(10) Pub. No.: US 2026/0229240 A1
(43) Pub. Date: Aug. 6, 2026

(54) NEURAL AUDIO CODEC WITH CONTROLLABLE PER SUB-BAND BITRATES

(71) Applicant: Cisco Technology, Inc., San Jose, CA (US)

(72) Inventors: Kamil Krzysztof Wojcicki, Kangaroo Point (AU); Mansur Yesilbursa, Krakow (PL); Mengjun Leng, Cupertino, CA (US)

(21) Appl. No.: 19/045,702

(22) Filed: Feb. 5, 2025

(51) Int. Cl. G10L 19/038; G10L 25/30

(52) U.S. Cl. CPC G10L 19/038; G10L 25/30

(57) ABSTRACT

A method includes receiving an audio signal at a neural network-implemented audio encoder, encoding the audio signal with the neural network-implemented audio encoder according to frequency sub-bands to generate an embedding vector representative of a frame of the audio signal, vector quantizing the embedding vector according to the frequency sub-bands to generate respective codewords for each of the frequency sub-bands, and transmitting, in one or more packets, the respective codewords, or respective indexes thereof, to a remote endpoint.

### TECHNICAL FIELD

The present disclosure relates to audio processing, and more particularly to audio processing using a neural audio coding-decoding (codec) system that performs sub-band disentanglement.

### BACKGROUND

Audio coding/decoding (codec) systems play a role in real-time communication technologies, aiming to preserve audio content quality and intelligibility while minimizing bit consumption. The integration of machine learning techniques and the development of end-to-end neural codecs have driven advancements in bitrate reduction and audio quality.

In addition to encoding the audio signal, there is a role for audio enhancement in extensively utilized real-time communication solutions. Deep neural networks have shown promising results in addressing the challenges of audio enhancement in noisy and reverberant environments.

### BRIEF DESCRIPTION OF THE DRAWINGS

FIG. 1 is a system block diagram of a neural network audio codec system according to an example embodiment.

FIG. 2 is a diagram depicting end-to-end training of a neural network audio codec system according to an example embodiment.

FIG. 3 is another block diagram of an end-to-end neural network audio codec system according to an example embodiment.

FIG. 4 is a block diagram of an end-to-end neural network audio codec system with sub-band encoding enabled according to an example embodiment.

FIG. 5 is a block diagram of an end-to-end neural network audio codec system with sub-band encoding enabled, along with a selected disabled sub-band, according to an example embodiment.

FIG. 6 is a flowchart depicting a series of operations that may be executed by a neural network audio codec system according to an example embodiment.

FIG. 7 is a block diagram of a computing device that may be configured to host location sub-band encoding control logic, and to perform techniques described herein, according to an example embodiment.

### DETAILED DESCRIPTION

### Overview

A method of operating a neural network-implemented audio encoder is disclosed. The method may include receiving an audio signal at a neural network-implemented audio encoder, encoding the audio signal with the neural network-implemented audio encoder according to frequency sub-bands to generate an embedding vector representative of a frame of the audio signal, vector quantizing the embedding vector according to the frequency sub-bands to generate respective codewords for each of the frequency sub-bands, and transmitting, in one or more packets, the respective codewords, or respective indexes thereof, to a remote endpoint.

A device is also described and includes an interface configured to enable network communications, a memory, and one or more processors coupled to the interface and the memory, and configured to: receive an audio signal, encode the audio signal with a neural network-implemented audio encoder according to frequency sub-bands to generate an embedding vector representative of a frame of the audio signal, vector quantize the embedding vector according to the frequency sub-bands to generate respective codewords for each of the frequency sub-bands, and transmit, in one or more packets, the respective codewords, or respective indexes thereof, to a remote endpoint.

### Example Embodiments

### Neural Network Audio Codec System

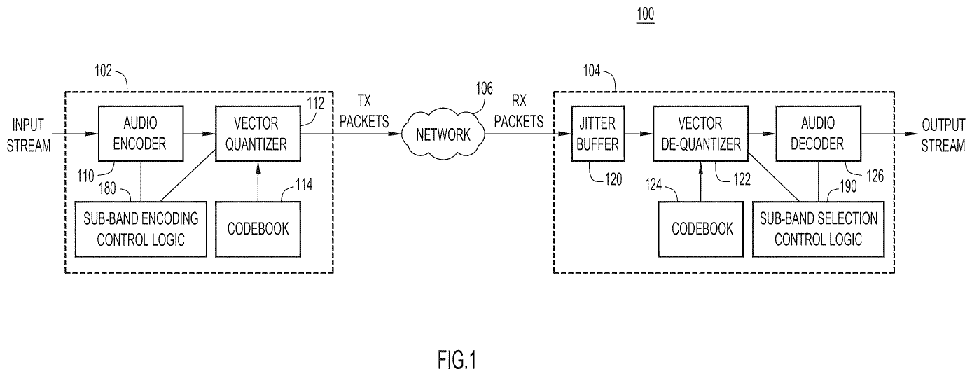

Reference is first made to FIG. 1. FIG. 1 shows a block diagram of a neural audio encoder/decoder (codec) system 100. The neural audio codec system 100 includes a transmit side 102 and a receive side 104 (e.g., a remote endpoint), which may be separate devices that are in communication with each other via network 106. The network 106 may be a combination of (wired or wireless) local area networks, (wired or wireless) wide area networks, public switched telephone network (PSTN), etc.

At the transmit side 102, there is an audio encoder 110 and a vector quantizer 112. The vector quantizer uses a codebook 114. The audio encoder 110 receives an input audio stream (that includes speech as well as artifacts and impairments, such as background noise). The audio encoder 110 may use a deep neural network that takes the input audio stream and transforms it, frame-by-frame, into high-dimensional embedding vectors that keep all the important information and optionally removes unwanted information such as the artifacts and impairments. The duration of the frames may be 10-20 millisecond (ms), for example. The audio encoder 110 may be composed of convolutional, recurrent, attentional, pooling, or fully connected neural layers as well as any suitable nonlinearities and normalizations. The vector quantizer 112 quantizes the high-dimensional vectors at the output of the audio encoder 110. These vectors are referred to as “embedding vectors” herein. For example, the vector quantizer 112 may use techniques such as Residual Vector Quantization by selecting a set of codewords (from the codebook 114) from each layer to optimize a criterion reducing quantization error at the output stream on receive side. The codewords, or indices of the selected codewords, for each frame are put into transmit (TX) packets and sent to the receive side 104, or they may be stored for later retrieval and use. In some implementations, the audio encoder 110 may generate the quantized vectors (indices) directly without the need for a separate vector quantizer 112.

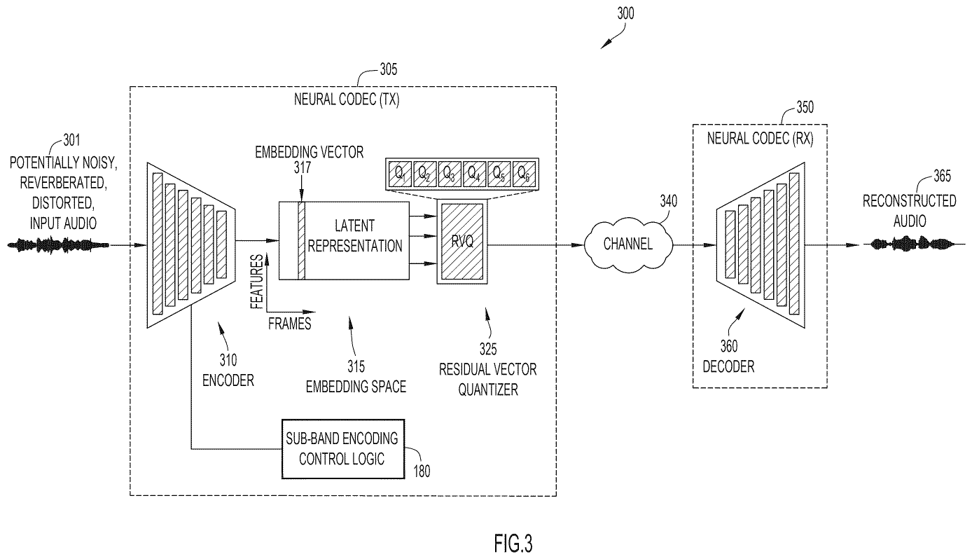

As noted, the audio encoder 110 may use a deep neural network that takes the input audio stream and transforms it, frame-by-frame, into high-dimensional embedding vectors that keep all the important information and optionally removes unwanted information such as the artifacts and impairments. Further, and in accordance with embodiments described later in connection with FIGS. 3-7, audio encoder 110 may be configured to selectively encode the input stream on a per sub-band basis, e.g., high frequency, medium frequency, and low frequency. The encoding of each such sub-band may be controlled separately, and when one or more sub-bands are disabled, the bits previously allocated to the-now disabled sub-bands may then be re-allocated to sub-bands that are sent to the receive side 104. Enabling or disabling a given sub-band may be controlled (either with a manual setting, or in an automated fashion, e.g., based on neural network control optimizing for a desired criterion) by sub-band encoding control logic 180.

The receive side 104 obtains receive (RX) packets from the network 106. At the receive side 104, there are a jitter buffer 120, vector de-quantizer 122, codebook 124 and an audio decoder 126. The jitter buffer 120 keeps track of the incoming packets, putting them in order and deciding when to process and play a packet. The jitter buffer 120 may also be used to detect packet loss. The vector de-quantizer 122 de-quantizes received codeword indices and, using the codebook 124, outputs recovered embedding vectors. The audio decoder 126 decodes the embedding vectors to produce an output audio stream. Sub-band selection control logic 190 may be employed to select whether to decode a given frequency sub-band.

Also shown is sub-band selection control logic 190 that may be configured, in accordance with an embodiment, to selectively process respective incoming separate sub-band streams from transmit side 102. As will be explained below, such processing may include separately de-quantizing, and/or selecting, which of the individual sub-band streams are to be played for a listener.

Though not specifically shown in FIG. 1, there may be an encoder, vector quantizer, vector de-quantizer and decoder at each device to enable two-way communications.

Techniques are provided for an artificial intelligence (AI) architecture built on the neural audio codec system 100 shown in FIG. 1. At the core of this architecture is a compact speech vector that has great potential for a wide range of speech AI and other applications. The proposed unified architecture offers a versatile solution applicable to various content, including but not limited to: speech enhancement (such as background noise removal, de-reverberation, speech super-resolution, bandwidth extension, gain control, and beamforming), packet loss concealment (with or without forward error correction (FEC)), acoustic/automatic speech recognition (ASR), speech synthesis, also referred to as text-to-speech (TTS), voice cloning and morphing, speech-to-speech translation (S2ST), and audio-driven large language model (AdLLR).

### Training the Neural Network Audio Codec System

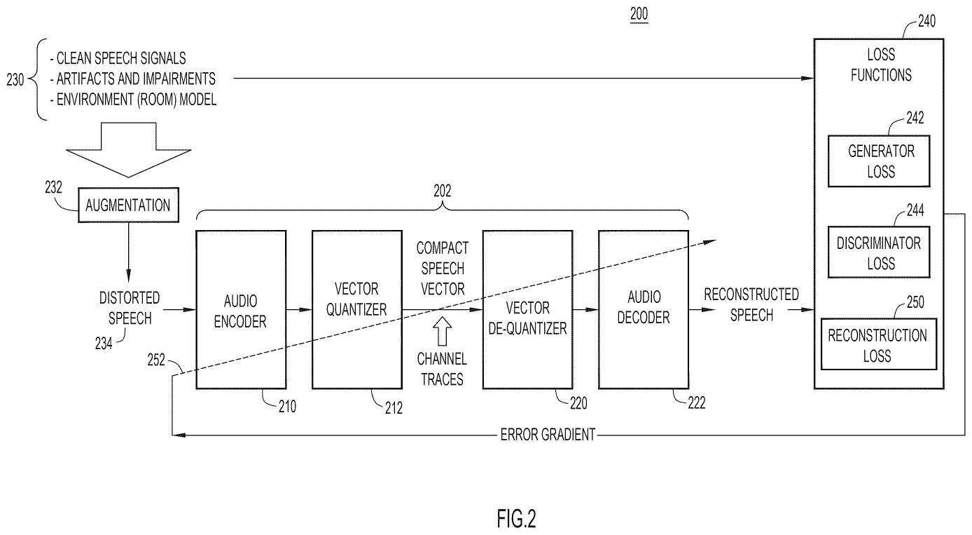

Reference is now made to FIG. 2. FIG. 2 shows an arrangement 200 by which components of a neural audio codec system 202 are trained end-to-end using thousands of hours of speech and artifacts and impairments. Similar to FIG. 1, the neural audio codec system 202 includes an audio encoder 210, vector quantizer 212, vector de-quantizer 220 and audio decoder 222, and each of these components may use a neural network model (or more generally machine learning-based model) for their operations.

To train the neural audio codec system 202, and as shown at reference numeral 230, various artifacts and impairments are applied to the clean speech signals through an augmentation operation 232 to produce distorted speech 234. The artifacts and impairments may include background noise, reverberation, band limitation, packet loss, etc. In addition, an environment model, such as a room model, may be used to impact the clean speech signals. The distorted speech 234 is then input into the neural audio codec system 202.

The training process involves applying loss functions 240 to the reconstructed speech that is output by the audio decoder 222. The loss functions 240 may include a generative loss function 242, a reconstruction loss function 250, and an adversarial/discriminator loss function 244. The loss functions 240 output an error gradient that is used to adjust parameters of the neural network models used by the audio encoder 210, vector quantizer 212, vector de-quantizer 220 and audio decoder 222, as shown at 252. Thus, the neural network models used by the audio encoder 210, vector quantizer 212, vector de-quantizer 220 and audio decoder 222 may be trained in an end-to-end hybrid manner using a mix of reconstruction and adversarial losses.

As a result of this training, the audio encoder 210 takes raw audio input and leverages a deep neural network to extract a comprehensive set of features that encapsulate intricate speech and background noise characteristics jointly or separately. The extracted speech features represent both the speech semantic as well as speech stationary attributes such as volume, pitch modulation, accent nuances, and more. This represents a departure from conventional audio codecs that rely on manually designed features, whereas in the embodiments presented herein, the neural audio codec systems learns and refines its feature extraction process from extensive and diverse datasets, resulting in a more versatile and generalized representation.

The output of the audio encoder 210 materializes as a series of embedding vectors, with each vector encapsulating a snapshot of audio attributes over a timeframe. The vector quantizer 212 further compresses the embedding vector into a compact speech vector, i.e., codewords, using a residual vector quantization (RVQ) model. Vector quantizer 212 may also be implemented using product vector quantization, also known as group vector quantization. Such an approach employs multiple layers, but unlike RVQ, each layer works in parallel. The embodiments described herein are not limited to any particular quantizer implementation. The codeword indices streams are ready for transmission or storage. At the receiving end, the audio decoder takes the compressed bitstream as input, reverses the quantization process, reconstructs the speech into time-domain waveforms.

The end-to-end training may result in a comprehensive and compact representation of clean speech. This is a data-driven compressed representation of speech, where the representation has a lower dimensionality that makes it easier to manipulate and utilize than if the speech were in its native domain. By “data-driven” it is meant that the representation of speech is developed or derived through ML-based training using real speech data, rather than a human conjuring the attributes for the representation. The data used to train the models may include a wide variety of samples of speech, languages, accents, different speakers, etc.

In the use case of speech enhancement, the compact speech vector represents “everything” to recover speech but discarding, or separating out, anything else related to artifacts or impairments. Thus, for speech enhancement applications, the neural audio codec system does not encode audio, but rather, encodes, individually, speech, music, background noise, etc. In so doing, the neural audio codec system can produce a richer and customizable experience for both the transmit side 102 and the receive side 104.

### Loss Functions Useful During Training

Reconstruction losses may be used to minimize the error between the clean signal, known as a target signal, x and an enhanced signal generated by the neural audio codec, denoted \hat{x}, which is denoised and dereverberated and/or with concealed packets/frames loss of its input signal y, noisy, reverberated audio signal and/or with lost packets/frames. One or more reconstruction losses may be used in the time domain or time-frequency domain.

A loss in the time domain may involve minimizing a distance between estimated clean \hat{x} and the target signal x time domain:

$${ℒ}_{t} = {{\sum }_{n = 1}}^{N} \vert x [ n ] - \hat{x} [ n ] \vert ,$$

where [symbol] is the L1 norm loss and N denotes to number of samples of x and x in the time domain, where L1 Norm is a sum of the magnitudes of the vectors in a space and is one way to measure distance between vectors (sum of absolute difference of components of the vectors). In some implementations, the L1 norm loss and/or the L2 norm loss may be used.

A weighted signal-to-distortion radio (weighted SDR) may be used, where the input signal y is represented as x with additive noise n: y=x+n, then SDR loss is defined as:

$${ℒ}_{SDR} ( x , \hat{x} ) = - \frac{〈 x , \hat{x} 〉}{‖ x ‖ ‖ \hat{x} ‖} ,$$

where the operator [symbol] , [symbol] represents the inner product and ∥,∥ represents Euclidean norm. This loss is phase sensitive with the range [−1,1]. For noise only samples, to be more precise, a noise prediction term is added to define the final weighted SDR loss:

$${ℒ}_{SDR} ( x , n , \hat{n} ) = {ℒ}_{SDR} ( x , \hat{x} ) + {ℒ}_{SDR} ( n , \hat{n} ) ,$$

where \hat{n}=y−\hat{x} is estimated noise.

Multi-scale Short-Time Fourier Transform (MS STFT) operates in the frequency domain using different window lengths. This approach of using various window lengths is inspired by the Heisenberg Uncertainty Principle, which shows that a larger window length gives greater frequency resolution but lower time resolution, and the opposite for a shorter window length. Therefore, the MS STFT uses a range of window lengths to capture different features of the audio waveform.

The loss is defined as:

$${ℒ}_{MSTFT} = {\sum }_{l = 1}^{L} {\sum }_{k = 1}^{K} \vert {S}^{w} [ l . k ] - {\hat{S}}^{w} [ l . k ] \vert + {α}_{w} {\sum }_{l = 1}^{L} {\sum }_{k = 1}^{K} \sqrt{{\vert log ( {S}^{w} [ l , k ] - log ( {\hat{S}}^{w} [ l . k ] \vert}^{2}} ,$$

where S^{w}[l, k] is the energy of the spectrogram at frame l and frequency bin k and characterized by a window w, K is the number of frequency bins, L is the number of frames and α_{w} is a parameter to balance between L1 Norm and L2 Norm part of the loss, where the L2 Norm is the square root of the sum of the entries of a vector. The second part of the loss is computed using a log operator to compress the values. Generally, most of the energy content of speech signal is concentrated below 4 kHz. Therefore, the energy magnitude in lower frequency components is significantly higher than higher frequency components, with going to log domain, the magnitude of higher frequencies and lower frequencies get closer, thus more focus on higher frequency components compared to linear scale. A high-pass filter can be designed to improve performance for high-frequency content.

A Mean Power Spectrum (MPS) loss function aims to minimize the discrepancy between the mean power spectra of enhanced and clean audio signals in the logarithmic domain using L2 Norm.

The power spectrum of the signal is computed as below:

$$P ( x ) = 1 / N {{\sum }_{n = 0}}^{N - 1} {\vert {X}_{n} \vert}^{2} ,$$

where P(x) is the mean power spectrum of signal x, X is FFT/STFT of signal x.

A logarithm may be applied to the mean power spectrum (MPS), such that the logarithmic power spectrum of a signal x is:

$$L ( x ) = 10 {log}_{10} ( P ( x ) + ϵ ) ,$$

where ∈ is a small constant to prevent the logarithm of zero.

The MPS loss between the enhanced and clean signals can then be defined as the L2 Norm of the difference between their logarithmic power spectra:

$${ℒ}_{MPS} ( \hat{x} , x ) = \sqrt{\sum {( L ( \hat{x} ) - L ( x ) )}^{2}} .$$

Generative Adversarial Networks (GANs) comprise two main models: generator and discriminator. In the neural network codec system, the audio encoder, vector quantizer and audio decoder may employ GAN generator and discriminator models. As an example, two adversarial loss functions could be used in the neural audio codec system: Lease-squared adversarial loss functions and hinge loss functions.

Least square (LS) loss functions for discriminator and generator may be respectively defined as:

$${ℒ}_{ADV} ( D ; G ) = {E}_{( x , s )} [ {( D ( x ) - 1 )}^{2} + {D ( G ( y ) )}^{2} ] ,$$

$${ℒ}_{ADV} ( G ; D ) = {E}_{d} [ {D ( G ( y ) - 1 )}^{2} ] ,$$

For discriminator loss, [symbol] _{ADV}(D; G), E_{(,)} is the expectation operator, D(x), is the output of the discriminator for a real signal x, D(G(y)) is the discriminator output of enhanced (fake) signal and [symbol] _{ADV}(G; D) is the generator loss.

Hinge loss for the discriminator and generator may be defined as:

$${ℒ}_{ADV} ( D ; G ) = {E}_{( x , y )} [ max ( 1 - D ( x ) , 0 ) + max ( 0 , 1 + D ( G ( y ) ) ) ] ,$$

$${ℒ}_{ADV} ( G ; D ) = {E}_{y} [ max ( 1 - D ( G ( y ) ) , 0 ) ] ,$$

Hinge loss may be preferred over least square loss because in the case of discriminator loss, hinge loss tries to maximize the distance between the real signal and fake signal while LS loss tries to score 1 when the input is a “real signal” and 0 when the input is “fake signal”.

In addition to above-mentioned losses, feature matching may be used to minimize the difference between the intermediate features of each layer of real and generated signals when passed through the discriminator. Instead of solely relying on the final output of the discriminator, feature matching ensures that the generated samples have similar feature statistics to real samples at various levels of abstraction. This helps in stabilizing the training process of adversarial networks by providing smoother gradients. Feature matching loss may be defined as:

$${ℒ}_{FM} ( G ; D ) = [ {{\sum }_{i = 1}}^{T} \frac{1}{{N}_{i}} {‖ {D}^{i} ( x ) - {D}^{i} ( G ( y ) ) ‖}_{1} ] ,$$

where Nᵢ is the number of layers in the discriminator D, and superscript i is used to design the layer number. Note that feature matching loss updates only generator parameters.

Several different discriminator models may be suitable for use in the training arrangement of FIG. 2, including: Multi-Scale Discriminator (MSD), Multi-Period Discriminator (MPD) and Multi-Scale Short-Time Fourier Transform (MS-STFT).

For a MSD, the discriminator is looking at the waveform at the different sampling rates. The waveform discriminators have the same network architecture but use different weights. Each network is composed of n number of strided 1-dimensional (1D) convolution blocks, an additional 1D convolution, and global average pooling to output a real-value score. A “leaky” rectifier linear unit (Leaky ReLu) may be used between the layers for the purpose of non-linearity of the network.

A MPD operates on the time-domain waveform and tries to capture implicit periodicity structure of the waveform. In an MPD discriminator, different periods of the waveform are considered. For each period, the same network architecture, with different weights, are used. The network consists of n strided two-dimensional (2D) convolution blocks, an additional convolution, and a global average pooling for outputting a scalar score. In the convolution block weight normalization may be used along with a Leaky ReLu as an activation function.

An MS-STFT discriminator, unlike the MSD and MPD, operates in the frequency domain using a Short-Time Fourier Transform (STFT). This discriminator enables the model to analyse the spectral content of the signal. The MS-STFT discriminator analyses the “realness” of the signal at multiple time-frequency scales or resolutions. Having spectral content of the waveform in various resolutions, the model is able to analyze the “realness” of the waveform more profoundly. The MS-STFT discriminator may be composed of t equivalent networks that handle multi-scaled complex-valued STFTs with incremental window lengths and corresponding hop sizes. Each of these networks contains a 2D convolutional layer, with weight normalization applied, featuring a nxm kernel size and c number of channels, followed by a Leaky ReLu non-linear activation function. Subsequent 2D convolution layers have dilation rates in the temporal dimension and an output stride of j across the frequency axis. At the end we have dxd convolution with stride 1 followed by flatten layer to get the output scores.

Finally, the total loss of adversarial training may be defined as:

$$ℒ = {λ}_{FM} {ℒ}_{FM} + {λ}_{MSTFT} {ℒ}_{MSTFT} + {λ}_{G} {ℒ}_{ADV} ( G ; D ) + {λ}_{D} {ℒ}_{ADV} ( D ; G ) + {λ}_{t} {ℒ}_{t} + {λ}_{SDR} {ℒ}_{SDR} + {λ}_{MPS} {ℒ}_{MPS} ,$$

where λ coefficients are used to give more weights to some losses compared to the other losses, [symbol] _{FM} is the feature matching loss. [symbol] _{MSTFT} is MS-STFT loss that can be replaced by [symbol] _{MSD} for MSD discriminator or [symbol] _{MPD} for MPD discriminator.

Any one or more of the loss functions referred to above, or other loss functions now known or hereinafter developed, may be used in the training process depicted in FIG. 2. The architecture of the end-to-end training, from the encoder side to the decoder side, produces the embedding vectors that can be exploited for a variety of applications as described below. The training results in an embedding vector representation that lends itself to convergence, accuracy, etc. Again, this is a result of the characteristics that are trained for, selection of loss functions, training content, selection criteria for epics, etc., to arrive at the embedding vectors that have desirable characteristics of: rejecting non-speech (for speech enhancement applications), easy to encode speech, and durability across speech applications.

### Sub-Band Encoding and Control

In one possible implementation, and as explained in connection with FIG. 1, the input audio is encoded and quantized in a single stream and sent to the receive side 104. To enhance a user's experience, and system performance, the embodiments described herein may further implement frequency sub-band encoding in conjunction with sub-band encoding control logic 180. That is, in accordance with an embodiment, not only is the neural audio codec system 202 of FIG. 2 trained as described above, but it may also be trained based on separated frequency sub-bands. Having a sub-band codec structure allows for independent bitrate control for separate sub-bands. In this regard, optionally eliminating higher frequency information and allocating more bits to low frequency speech content can improve the quality and intelligibility of the audio at the receive side 104, especially in adverse scenarios such as low signal-to-noise ratio (SNR). In one possible implementation, the system may transmit audio at a 16 kHz audio rate by turning off sub-bands above 8 kHz (i.e., setting their bitrate to zero).

The embodiments described herein are configured to achieve control over several encoding operations of neural audio codec system 100. Specifically, the described embodiments provide (a) control over bitrate on a per sub-band (per frequency range) basis, (b) control over audio bandwidth (frequency range) for transmission, (c) control over selecting different effective sampling rates for the incoming audio, and (d) control of per frequency sub-band compute.

Controlling bitrate on a per sub-band basis provides the flexibility for bitrate allocation that optimizes overall quality for a fixed bitrate budget, e.g., more (less) bits for low (high) frequencies can lead to better overall quality. Regarding controlling different sampling rates, one scenario in which this may be implemented is where 0-8 kHz embeddings are transmitted, and a decoder is trained for synthesizing 16 kHz speech. Such a decoder could be selected and used. Likewise, if codewords for 0-16 kHz bandwidth are being transmitted, then a different decoder could be selected to synthesize 32 kHz audio.

Enabling control over audio bandwidth, selecting different sampling rates (in certain scenarios), and per frequency sub-band compute control provides more flexibility for supported bandwidths and (at least partial support) for various audio rates. Per frequency sub-band compute control may also save on partial encoder compute for unused (turned off) sub-bands/bandwidths.

In an embodiment, neural network disentangling techniques can be used to separate speech from noise and music, as well as disentangling speech factors such as speaker identity, pitch, linguistic content, etc. These same disentangling techniques may also be leveraged to separate embedding representations according to frequency sub-bands. Specifically, the embodiments described herein provide a neural audio codec with sub-band specific partitioning of the latent (embedding) domain by using disentangling representations.

The sub-band bitrate control may be achieved by having a dedicated residual vector quantizer (RVQ) for each sub-band, thereby allowing the freedom to choose how many layers, codewords, and hence bits, are used to represent a given sub-band in transmission. As in a non-per-sub-band system, it is possible to adjust, at inference time (and on the fly), the bitrate for the given sub-band, i.e., by controlling how many layers of the RVQ are active.

As is explained further below, sub-band compute control can be achieved by having sub-band specific prediction heads as part of the encoder configuration. The compute savings can be realized if a given sub-band is switched off (not transmitted). This can be useful if transmitting audio of lower bandwidth (e.g., 0-8 kHz).

To implement such a neural encoder with frequency sub-band control, the neural audio codec system 202 of FIG. 2 is also trained with band limited inputs and targets (isolating a specific sub-band) and by applying a mask weight of 1 to the portion of the embedding dimensions that is to be used to model representation of speech information specific to that given sub-band, while masking with a 0 weight all other embedding dimensions. This is the strategy to realize sub-band disentangling.

Reference is now made to FIG. 3, which is another block diagram of an end-to-end neural network audio codec system 300 that includes a transmit end 305 and a receive end 350. For purposes of illustration, assume a sampling rate of 32 kHz for input audio 301 and a total of 6 kbps available for transmission. Input audio 301 is converted by encoder 310 to a 320-dimensional latent representation in an embedding space 315, with a given embedding vector 317 extending vertically, as highlighted. The given embedding vector 317 represents all of the features of one frame. As those skilled in the art appreciate, all audio content in the embedding space 315 is “scrambled” (i.e., uninterpretable) in this domain.

In this illustration, sub-band encoding control logic 180 has not selected sub-band encoding, or is configured to select, instead, a parallel, non-sub-band encoding technique. As such, there is no frequency/sub-band dependency shown. The entire 16 kHz bandwidth is represented by the 320 dimensions of each embedding vector in the embedding space 315. The entire embedding space 315 is then quantized by a residual vector quantizer 325 made up, potentially, of multiple quantizers Q₁, Q₂, Q₃, Q₄, Q₅, Q₆. Notably, without sub-band encoding selected, there is no direct way to control audio bandwidth or bitrate per frequency band at inference time. Codeword indexes, determined by residual vector quantizer 325, are transmitted via channel 340 to a decoder 360 in the receive end 350. The decoder 360 uses the received indexes to feed corresponding codewords through its layers to generate or synthesize reconstructed audio 365.

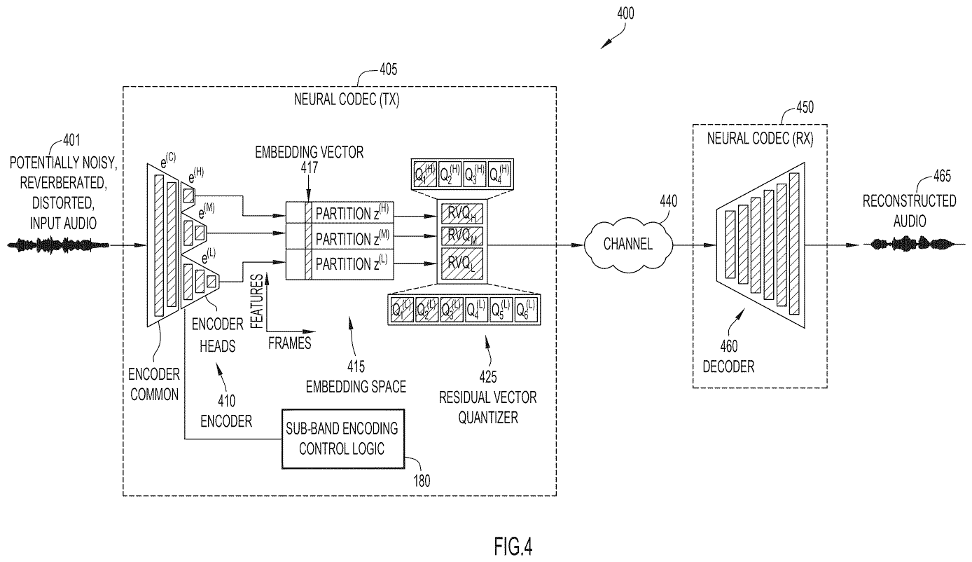

FIG. 4 is a block diagram of an end-to-end neural network audio codec system 400 with sub-band encoding enabled according to an example embodiment. The system 400 includes a transmit end 405 and a receive end 450. For purposes of illustration, assume a sampling rate of 32 kHz for input audio 401 and a total of 6 kbps available for transmission. Input audio 401 is converted by encoder 410 to embedding vectors in embedding space 415 (also referred to as a “latent representation”), with a given embedding vector 417 extending vertically, as highlighted. The given embedding vector 317 represents all of the features of one frame. As those skilled in the art appreciate, all audio content in the embedding space 415 is “scrambled” (i.e., uninterpretable) in this domain.

In this illustration, sub-band encoding control logic 180 has selected sub-band encoding, or is configured to select a dedicated sub-band encoder. In this regard, encoder 410 comprises multiple common layers (e^{(C)}) that are active regardless of the sub-bands that might be enabled for transmission, along with respective dedicated sub-band encoder heads low (e^{(L)}), mid (e^{(M)}) and high (e^{(H)}), corresponding to different sub-bands, e.g., 0-4 kHz, 4-8 kHz, and 8-16 kHz, respectively.

Each of the encoder sub-band heads (e^{(L)}), (e^{(M)}), and (e^{(H)}) can be enabled, individually, based on whether given specific sub-band information is to be quantized and transmitted. Otherwise, a given sub-band head may be disabled, thus saving compute power.

As shown in FIG. 4, each encoder head produces a respective partition Z^{(H)}, Z ^{(M)}, Z ^{(L)} of the embedding space 415 that encodes information specific to its frequency range. Each such sub-band partition Z^{(H)}, Z ^{(M)}, Z ^{(L)} is then quantized by a separate vector quantizer RVQ_{H}, RVQ_{M}, RVQ_{L} in the residual vector quantizer 425, thus allowing for separate bitrate control per sub-band.

Still with reference to FIG. 4, in this example, the low sub-band 0-4 kHz uses 3 layers each at 1 kbps for a total of 3 kbps that are allocated to representing low frequencies, 2 kbps are allocated to the mid sub-band 4-8 kHz, and 1 kbps is allocated to the high sub-band 8-16 kHz. In this way, the bitrate of each sub-band can be controlled independently and potentially in a dynamic fashion.

Codewords or codeword indexes, determined by residual vector quantizer 425, are then transmitted via channel 440 to a decoder 460 in the receive end 450. The decoder 460 uses the received indexes to feed corresponding codewords through its layers to generate or synthesize reconstructed audio 465. In the event RVQ_{H}, RVQ_{M}, and RVQ_{L} generated respective codewords, then decoder 460 may be configured to decode on a per-sub-band basis and synthesize or combine separately generated streams of audio.

In connection with training encoder 410, and as shown, assume encoder 410 is configured to divide a 32 kHz audio signal into 3 sub-bands: 0-4 kHz, 4-8 kHz and 8-16 kHz. To train a model to disentangle these three bands in the embedding space 415, three target signals are composed, each sampled at 32 kHz and each containing the energy only in the respective sub-band. The target signals may be obtained, for example, using the quadrature mirror filter bank method.

Training logic may be implemented to randomly sample a subset of sub-bands to be synthesized in the decoder 460 (e.g., 0-4 kHz and 4-8 kHz). More generally, there would be 2ⁿ−1 valid sub-band training combinations where n is the total number of sub-bands. Empty set would be excluded from the training since it would not generate useful gradients for the training. The probability distribution of the sub-band combinations may or may not be uniform. Realistically, the 0-4 kHz sub-band would likely be enabled in an audio communication setting, and hence may be thought to be enabled all the time during training to improve its quality. However, the 0-4 kHz band should also be disabled by some nonzero percentage in the training to achieve proper sub-band disentanglement in the embedding space 415.

To disable a certain band, it is sufficient to apply a zero mask to its corresponding VQ dimensions. The target signal for each sub-band combination may be obtained by summing up the corresponding sub-band target signals.

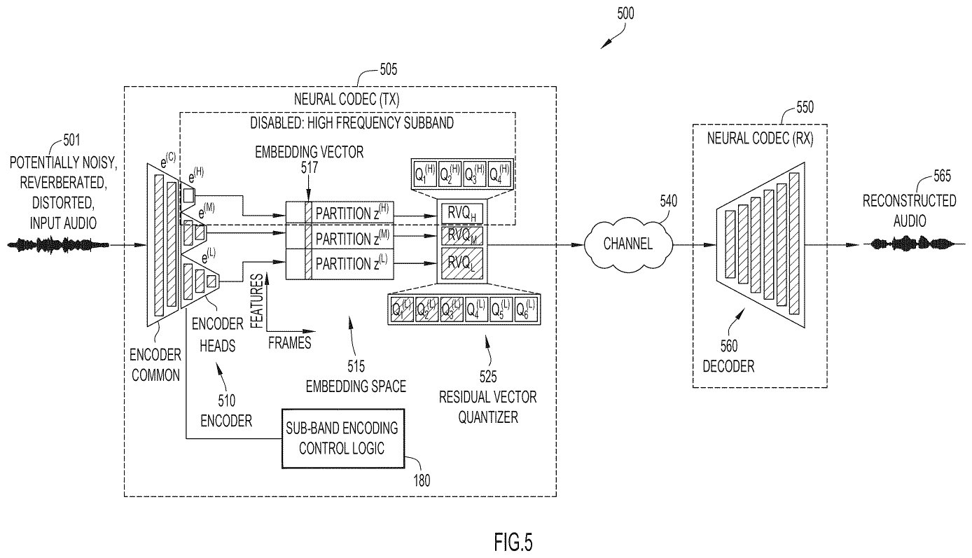

FIG. 5 is a block diagram of an end-to-end neural network audio codec system with sub-band encoding enabled, but with a selected sub-band disabled, according to an example embodiment. The system 500 includes a transmit end 505 and a receive end 550. For purposes of illustration, assume a sampling rate of 32 kHz for input audio 501 and a total of 6 kbps available for transmission. Input audio 501 is converted by encoder 510 to a 320-dimensional embedding space 515 (also referred to as a “latent representation”), with a given embedding vector 517 extending vertically, as highlighted. The given embedding vector 517 represents all of the features of one frame. In this case, as those skilled in the art appreciate, the sub-bands are disentangled, but within sub-bands the representations may be scrambled, unless the encoder 510 is configured to provide within-sub-band disentangling, e.g., in terms of speech vs noise, etc.

In this illustration, sub-band encoding control logic 180 has disabled sub-band encoding for the high sub-band (e^{(H)}). As such, encoder 510 executes multiple common layers (e^{(C)}) that are active regardless of the sub-bands that might be enabled, along, in this case, with respective dedicated sub-band encoder heads low (e^{(L)}) and mid (e^{(M)}) (with high head (e^{(H)}) being disabled), corresponding to different sub-bands, e.g., 0-4 kHz and 4-8 kHz, respectively. A disabled high head (e (H)) saves computer power.

As shown in FIG. 5, RVQ_{H} of residual vector quantizer 525 is also disabled thus leading to savings in computer power, as well, and bitrate. The bitrate savings could potentially be reallocated to the mid or low quantizers RVQ_{M}, RVQ_{L}, if desired. Ultimately, codewords or codeword indexes, determined by residual vector quantizer 425, are transmitted via channel 540 to a decoder 560 in the receive end 550. The decoder 560 uses the received indexes to feed corresponding codewords through its layers to generate or synthesize reconstructed audio 565. Given the lack of codewords from RVQ_{H}, decoder 560 is fed with the received mid and low sub-band codewords, with zeros used for the high sub-band codewords. Alternatively, a dedicated (tailored) lower-compute 8 kHz audio bandwidth decoder could be implemented.

Thus, in the scenario depicted by FIG. 5, the low sub-band 0-4 kHz uses 3 layers each at 1 kbps for a total of 3 kbps that are allocated to representing low frequencies, and 2 kbps are allocated to the mid sub-band 4-8 kHz. The remaining 1 kbps in the 6 kbps system may be re-allocated as mentioned above.

On the receive side, decoder 560 may be implemented as a single decoder which could synthesize any subset combinations of the sub-bands or by a set of dedicated decoders (one for each sub-band). In the latter scenario, each dedicated decoder is configured to receive a certain sub-band's codeword indices and synthesizes the sub-band's content in the original signal sampling rate. To obtain the final output signal, it is sufficient to add up the outputs of the active dedicated decoders.

For both decoder scenarios (single or dedicated), extra information is provided to properly de-quantize the bitstream. For example, consider a scenario where all the sub-bands except the 0-4 kHz sub-band were disabled on the TX side. The RX side would have no way of knowing which sub-band the received information belongs to. Therefore, in an embodiment, the TX side is configured to send additional information to indicate to the decoder 560 which sub-bands are active. The additional bits needed per sub-band would be equal to log 2N where N is the number of sub-bands. For example, 1 extra bit of information is needed per sub-band for a system with 2 sub-bands. Total additional bits needed for transmission would be K*log₂N where K is the number of active sub-bands and N is the total number of sub-bands.

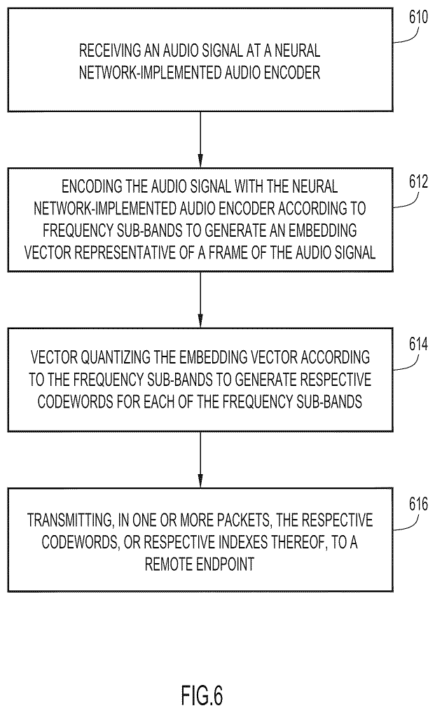

FIG. 6 is a flowchart depicting a series of operations that may be executed by a neural audio codec system according to an example embodiment. At 610, an operation includes receiving an audio signal at a neural network-implemented audio encoder. At 612, an operation includes encoding the audio signal with the neural network-implemented audio encoder according to frequency sub-bands to generate an embedding vector representative of a frame of the audio signal. At 614, an operation includes vector quantizing the embedding vector according to the frequency sub-bands to generate respective codewords for each of the frequency sub-bands. And, at 616, an operation includes transmitting, in one or more packets, the respective codewords, or respective indexes thereof, to a remote endpoint.

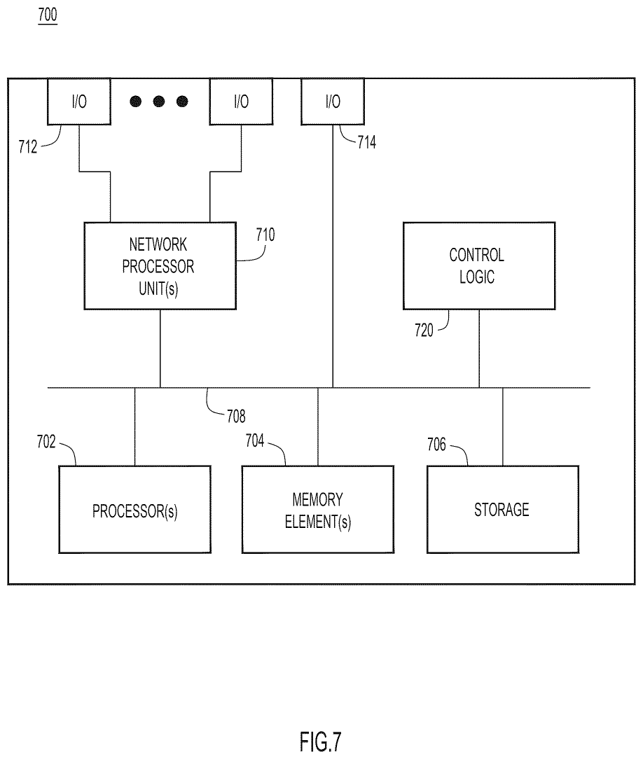

FIG. 7 is a block diagram of a computing device that may be configured to host sub-band encoding control logic 180 and/or sub-band selection control logic 190, and to perform techniques described herein, according to an example embodiment. In various embodiments, a computing device, such as computing device 700 or any combination of computing devices 700, may be configured as any entity/entities as discussed for the techniques depicted in connection with FIGS. 1-6 in order to perform operations of the various techniques discussed herein.

In at least one embodiment, the computing device 700 may include one or more processor(s) 702, one or more memory element(s) 704, storage 706, a bus 708, one or more network processor unit(s) 710 interconnected with one or more network input/output (I/O) interface(s) 712, one or more I/O interface(s) 714, and control logic 720. In various embodiments, instructions associated with logic for computing device 700 can overlap in any manner and are not limited to the specific allocation of instructions and/or operations described herein.

In at least one embodiment, processor(s) 702 is/are at least one hardware processor configured to execute various tasks, operations and/or functions for computing device 700 as described herein according to software and/or instructions configured for computing device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 704 and/or storage 706 is/are configured to store data, information, software, and/or instructions associated with computing device 700, and/or logic configured for memory element(s) 704 and/or storage 706. For example, any logic described herein (e.g., control logic 720) can, in various embodiments, be stored for computing device 700 using any combination of memory element(s) 704 and/or storage 706. Note that in some embodiments, storage 706 can be consolidated with memory element(s) 704 (or vice versa) or can overlap/exist in any other suitable manner.

In at least one embodiment, bus 708 can be configured as an interface that enables one or more elements of computing device 700 to communicate in order to exchange information and/or data. Bus 708 can be implemented with any architecture designed for passing control, data and/or information between processors, memory elements/storage, peripheral devices, and/or any other hardware and/or software components that may be configured for computing device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 710 may enable communication between computing device 700 and other systems, entities, etc., via network I/O interface(s) 712 (wired and/or wireless) to facilitate operations discussed for various embodiments described herein. In various embodiments, network processor unit(s) 710 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 700 and other systems, entities, etc. to facilitate operations for various embodiments described herein. In various embodiments, network I/O interface(s) 712 can be configured as one or more Ethernet port(s), Fibre Channel ports, any other I/O port(s), and/or antenna(s)/antenna array(s) now known or hereafter developed. Thus, the network processor unit(s) 710 and/or network I/O interface(s) 712 may include suitable interfaces for receiving, transmitting, and/or otherwise communicating data and/or information in a network environment.

I/O interface(s) 714 allow for input and output of data and/or information with other entities that may be connected to computing device 700. For example, I/O interface(s) 714 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 720 can include instructions that, when executed, cause processor(s) 702 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 720) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 704 and/or storage 706 can store data, software, code, instructions (e.g., processor instructions), logic, parameters, combinations thereof, and/or the like used for operations described herein. This includes memory element(s) 704 and/or storage 706 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IOT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In sum, a method may include receiving an audio signal at a neural network-implemented audio encoder, encoding the audio signal with the neural network-implemented audio encoder according to frequency sub-bands to generate an embedding vector representative of a frame of the audio signal, vector quantizing the embedding vector according to the frequency sub-bands to generate respective codewords for each of the frequency sub-bands, and transmitting, in one or more packets, the respective codewords, or respective indexes thereof, to a remote endpoint.

In the method, the embedding vector may be a partitioned embedding vector that is partitioned according to the frequency sub-bands.

The method may further include vector quantizing the partitioned embedding vector with vector quantizers respectively corresponding to the frequency sub-bands in the partitioned embedding vector.

The method may further include separating the audio signal according to frequency sub-bands by using neural network encoding disentangling techniques.

The method may further include encoding the audio signal according to the frequency sub-bands using respective encoding heads respectively dedicated to the frequency sub-bands.

In the method, at least two of the respective encoding heads may be implemented with different numbers of layers of the neural network-implemented audio encoder.

The method may further include enabling one or more of the respective encoding heads in response to user input.

The method may further include disabling one or more of the respective encoding heads in response to user input.

The method may further include allocating bits of a bit rate to frequency sub-bands that have not been disabled.

The method may further include training the neural network-implemented audio encoder with frequency band limited inputs and targets.

In another embodiment, a device may be provided and may include an interface configured to enable network communications, a memory, and one or more processors coupled to the interface and the memory, and configured to: receive an audio signal, encode the audio signal with a neural network-implemented audio encoder according to frequency sub-bands to generate an embedding vector representative of a frame of the audio signal, vector quantize the embedding vector according to the frequency sub-bands to generate respective codewords for each of the frequency sub-bands, and transmit, in one or more packets, the respective codewords, or respective indexes thereof, to a remote endpoint.

In the device, the embedding vector may be a partitioned embedding vector that is partitioned according to the frequency sub-bands.

In the device, the one or more processors may be further configured to vector quantize the partitioned embedding vector with vector quantizers respectively corresponding to the frequency sub-bands in the partitioned embedding vector.

In the device, the one or more processors may be further configured to separate the audio signal according to frequency sub-bands by using neural network encoding disentangling techniques.

In the device, the one or more processors may be further configured to encode the audio signal according to the frequency sub-bands using respective encoding heads respectively dedicated to the frequency sub-bands.

In the device, at least two of the respective encoding heads may be implemented with different numbers of layers of the neural network-implemented audio encoder.

In the device, the one or more processors may be further configured, in response to user input, to disable one or more of the respective encoding heads.

In yet another embodiment, one or more non-transitory computer readable storage media encoded with instructions are provided and that, when executed by a processor, cause the processor to receive an audio signal, encode the audio signal with a neural network-implemented audio encoder according to frequency sub-bands to generate an embedding vector representative of a frame of the audio signal, vector quantize the embedding vector according to the frequency sub-bands to generate respective codewords for each of the frequency sub-bands, and transmit, in one or more packets, the respective codewords, or respective indexes thereof, to a remote endpoint.

The embedding vector may be a partitioned embedding vector that is partitioned according to the frequency sub-bands.

The instructions may be further configured to vector quantize the partitioned embedding vector with vector quantizers respectively corresponding to the frequency sub-bands in the partitioned embedding vector.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
receiving an audio signal at a neural network-implemented audio encoder;
encoding the audio signal with the neural network-implemented audio encoder according to frequency sub-bands to generate an embedding vector representative of a frame of the audio signal;
vector quantizing the embedding vector according to the frequency sub-bands to generate respective codewords for each of the frequency sub-bands; and
transmitting, in one or more packets, the respective codewords, or respective indexes thereof, to a remote endpoint.

2. The method of claim 1, wherein the embedding vector is a partitioned embedding vector that is partitioned according to the frequency sub-bands.

3. The method of claim 2, further comprising vector quantizing the partitioned embedding vector with vector quantizers respectively corresponding to the frequency sub-bands in the partitioned embedding vector.

4. The method of claim 1, further comprising separating the audio signal according to frequency sub-bands by using neural network encoding disentangling techniques.

5. The method of claim 1, further comprising encoding the audio signal according to the frequency sub-bands using respective encoding heads respectively dedicated to the frequency sub-bands.

6. The method of claim 5, wherein at least two of the respective encoding heads are implemented with different numbers of layers of the neural network-implemented audio encoder.

7. The method of claim 5, further comprising enabling one or more of the respective encoding heads in response to user input.

8. The method of claim 5, further comprising disabling one or more of the respective encoding heads in response to user input.

9. The method of claim 8, further comprising allocating bits of a bit rate to frequency sub-bands that have not been disabled.

10. The method of claim 1, further comprising training the neural network-implemented audio encoder with frequency band limited inputs and targets.

11. A device comprising:
an interface configured to enable network communications;
a memory; and
one or more processors coupled to the interface and the memory, and configured to:
receive an audio signal;
encode the audio signal with a neural network-implemented audio encoder according to frequency sub-bands to generate an embedding vector representative of a frame of the audio signal;
vector quantize the embedding vector according to the frequency sub-bands to generate respective codewords for each of the frequency sub-bands; and
transmit, in one or more packets, the respective codewords, or respective indexes thereof, to a remote endpoint.

12. The device of claim 11, wherein the embedding vector is a partitioned embedding vector that is partitioned according to the frequency sub-bands.

13. The device of claim 12, wherein the one or more processors are further configured to vector quantize the partitioned embedding vector with vector quantizers respectively corresponding to the frequency sub-bands in the partitioned embedding vector.

14. The device of claim 11, wherein the one or more processors are further configured to separate the audio signal according to frequency sub-bands by using neural network encoding disentangling techniques.

15. The device of claim 11, wherein the one or more processors are further configured to encode the audio signal according to the frequency sub-bands using respective encoding heads respectively dedicated to the frequency sub-bands.

16. The device of claim 15, wherein at least two of the respective encoding heads are implemented with different numbers of layers of the neural network-implemented audio encoder.

17. The device of claim 15, wherein the one or more processors are further configured, in response to user input, to disable one or more of the respective encoding heads.

18. One or more non-transitory computer readable storage media encoded with instructions that, when executed by a processor, cause the processor to:
receive an audio signal;
encode the audio signal with a neural network-implemented audio encoder according to frequency sub-bands to generate an embedding vector representative of a frame of the audio signal;
vector quantize the embedding vector according to the frequency sub-bands to generate respective codewords for each of the frequency sub-bands; and
transmit, in one or more packets, the respective codewords, or respective indexes thereof, to a remote endpoint.

19. The one or more non-transitory computer readable storage media of claim 18, wherein the embedding vector is a partitioned embedding vector that is partitioned according to the frequency sub-bands.

20. The one or more non-transitory computer readable storage media of claim 19, wherein the instructions are configured to vector quantize the partitioned embedding vector with vector quantizers respectively corresponding to the frequency sub-bands in the partitioned embedding vector.
